(19) United States
(12) Patent Application Publication
(10) Pub. No.: US 2013/0234384 A1
(43) Pub. Date: Sep. 12, 2013

(54) STAPLING DEVICE FOR USE WITH PRINTING DEVICE

(71) Applicants: Chung-Kai Wang, Taipei (TW); Ching-Tse Wang, Taipei (TW); Chung-Jung Chiu, Taipei (TW); Wen-Lung Hung, Taipei (TW)

(72) Inventors: Chung-Kai Wang, Taipei (TW); Ching-Tse Wang, Taipei (TW); Chung-Jung Chiu, Taipei (TW); Wen-Lung Hung, Taipei (TW)

(73) Assignee: PRIMAX ELECTRONICS LTD., Taipei (TW)

(21) Appl. No.: 13/493,419

(22) Filed: Jun. 11, 2012

(30) Foreign Application Priority Data
Mar. 9, 2012 (TW) 101108095

(51) Int. Cl. B41L 43/12

(52) U.S. Cl. 270/58.08

(57) ABSTRACT

A stapling device for use with a printing device is provided. The stapling device is disposed on the printing device. The stapling device includes an exit, a conveying channel, and a channel base plate. The channel base plate is located at a bottom side of said first conveying channel. In addition, the channel base plate has a movable contact plate, which may be moved relative to the channel base plate. In a case that a paper jam event occurs within the stapling device, the user may move the movable contact plate. As the movable contact plate is moved, the jammed paper sheet is correspondingly moved to a position near the exit. Consequently, the jammed paper sheet can be easily removed through the exit by the user.

### FIELD OF THE INVENTION

The present invention relates to a stapling device, and more particularly to a stapling device for use with a printing device.

### BACKGROUND OF THE INVENTION

A paper stapler is a widely-used stapling device. When the handle of the paper stapler is manually pressed down by the user, a staple within the paper stapler is launched through plural paper sheets. Due to the pressing action, the ends of the staple are further folded, so that the plural paper sheets are jointed together. However, the process of manually operating the conventional stapling device is labor-intensive and time-consuming.

In some occasions, the plural paper sheets are manually jointed together by the stapling device after the plural paper sheets are printed and outputted from a printing device. Since the plural paper sheets are no longer disorderly spread everywhere, the joined paper sheets may be easily stored, managed or read. Generally, the printing device comprises a copier, a printer, or a multifunction peripheral which integrate a copier, a printer and a scanner. The printer is one of the most common printing devices. The duplex operation of a printing device will be illustrated as follows. For performing the duplex printing operation, a first page of a document file in a computer is firstly printed on a first side of a blank paper sheet. After the first page of the document file has been printed, the paper sheet with the printed image of the first page of the document file is turned over and then placed on a sheet input tray of the printing device. Then, a second page of the document is printed on a second side of the paper sheet. However, the process of repeatedly and manually turning over the paper sheet is troublesome. If the document contains a great number of pages, this drawback becomes more serious. Recently, a duplex printing device has been developed for automatically performing a duplex printing operation. The duplex printing device is widely used by many persons and companies.

Regardless of whether a single-side printing device or a duplex printing device is used, after the printing operation is completed, the printed paper sheet is ejected to a sheet ejecting tray of the printing device. Then, the plural paper sheets are removed from the sheet ejecting tray and stapled by a stapling device (e.g. a paper stapler). After the stapling operation is done, the plural paper sheets are joined together without being disorderly spread everywhere, and can be easily managed. However, since the printing process of the printing device should be performed before the plural paper sheets are manually stapled, the manual stapling process is more time-consuming. For solving these drawbacks, a stapling device for a printing device has been disclosed.

FIG. 1 is a schematic side view illustrating a conventional stapling device for use with a printing device. The printing device 1 comprises a stapling device casing 10, an entrance 11, a stapling module 12, a first conveying channel 13, plural first conveying roller assemblies 14, a first exit 15, and a sheet handling tray 16. The printing device 2 comprises a printing device casing 20, a sheet input tray 21, a printing module 22, a second conveying channel 23, plural second conveying roller assemblies 24, and a second exit 25. In addition, the printing device casing 20 has a top surface 201. The second exit 25 is formed in the top surface 201 of the printing device casing 20. The sheet input tray 21 is disposed within the printing device casing 20 for placing plural paper sheets P thereon. The second conveying channel 23 is disposed within the printing device casing 20. In addition, the second conveying channel 23 is arranged between the sheet input tray 21 and the second exit 25 for allowing the plural paper sheets P to go through. The plural second conveying roller assemblies 24 are disposed in the second conveying channel 23. By the plural second conveying roller assemblies 24, the plural paper sheets P on the sheet input tray 21 are transmitted to the second exit 25. The printing module 22 is disposed in the second conveying channel 23 for printing images on the plural paper sheets P.

The stapling device casing 10 is disposed on the top surface 201 of the printing device casing 20. In addition, the second exit 25 is sheltered by the stapling device casing 10. The first conveying channel 13 is in contact with the second exit 25, so that the first conveying channel 13 is in communication with the second conveying channel 23. The plural first conveying roller assemblies 14 are disposed in the first conveying channel 13. By the plural first conveying roller assemblies 14, the plural paper sheets P from the second conveying channel 23 may be transmitted to the sheet handling tray 16. The sheet handling tray 16 is used for supporting the plural paper sheets P. In addition, the stapling module 12 is located beside the sheet handling tray 16 for stapling the plural paper sheets P which are placed on the sheet handling tray 16. From the above discussions, after the plural paper sheets P are printed by the printing module 22 of the printing device 2, the plural paper sheets P are stapled by the printing device 1. In comparison with the manual stapling process, the use of the printing device 1 is time-saving because it is not necessary to wait for the completion of the printing operations on the plural paper sheets P and the automatic stapling process is faster.

Please refer to FIG. 1 again. The stapling device casing 10 is disposed over the printing device casing 20. In addition, the first conveying channel 13 is in upright communication with the second conveying channel 23. That is, the path of transmitting the plural paper sheets P is a straight line from bottom to top. Due to the upright arrangement, the overall height of the printing device 2 and the stapling device 1 will be largely increased.

Moreover, the printing device casing 20 has a rear surface 202. In a case that the printing device 2 has a failure (e.g. a paper jam event), the rear surface 202 may be opened, so that the user may easily repair the inner part of the printing device 2. However, if the plural paper sheets P are transmitted to the stapling device 1 and the paper jam event occurs within the stapling device 1 (see FIG. 2), some drawbacks occur. For example, since the second exit 25 and the second conveying channel 23 are too narrow, the user's finger fails to be inserted therein to touch the jammed paper sheet P. On the other hand, even if the rear surface 202 of the printing device casing 20 is opened, the jammed paper sheet P still fails to be touched or removed by the user's finger or any other tool because the distance between the rear surface 202 and the stapling module 12 is too long. For solving the paper jam event, it is necessary for the user to detach the stapling device casing 10.

Generally, the stapling device casing 10 is not detachably connected to the printing device casing 20. For solving the paper jam event, a specified tool is required to detach the stapling device casing 10. As known, the use of an additional tool to detach the stapling device casing 10 is troublesome.

Therefore, there is a need of providing an improved stapling device for use with a printing device.

### SUMMARY OF THE INVENTION

The present invention provides a stapling device for use with a printing device. The stapling device has a stapling device casing. The stapling device casing can be easily detached without the need of using an additional tool.

In accordance with an aspect of the present invention, there is provided a stapling device for use with a printing device. The stapling device is disposed on the printing device for stapling plural paper sheets from the printing device. The stapling device includes a stapling device casing, an entrance, a first exit, a first conveying channel, and a channel base plate. The entrance is formed in the stapling device casing and located near the printing device. The plural paper sheets outputted from the printing device are introduced into the stapling device through the entrance. The first exit is formed in the stapling device casing, wherein the plural paper sheets are exited out of the stapling device through the first exit. The first conveying channel is arranged between the entrance and the first exit for allowing the plural paper sheets to go through. The channel base plate is located at a bottom side of the first conveying channel. The channel base plate has a movable contact plate to be contacted with the plural paper sheets within the first conveying channel. By poking the movable contact plate, the movable contact plate is moved relative to the channel base plate, so that the plural paper sheets are correspondingly moved to a position near the first exit to be removed from the first exit.

In an embodiment, when the movable contact plate is moved from a sheet-feeding position to a jam-releasing position near the first exit, the plural paper sheets are removable from the movable contact plate through the first exit. When the movable contact plate is pushed to be moved from the jam-releasing position to the sheet-feeding position, the paper sheets are permitted to be transmitted along the first conveying channel.

In an embodiment, the movable contact plate has a pushing slice for contacting the plural paper sheets within the first conveying channel. When the movable contact plate is poked and moved relative to the movable contact plate, the plural paper sheets are pushed by the pushing slice to the position near the first exit, so that the plural paper sheets are removable through the first exit.

In an embodiment, the stapling device further includes a stapling module, a feed roller assembly, and a first conveying roller assembly. The stapling module is disposed within the stapling device casing and located over the first exit for stapling the plural paper sheets. The feed roller assembly is disposed in the first conveying channel and located near the entrance for transporting the plural paper sheets into the first conveying channel. The first conveying roller assembly is disposed on the channel base plate and located near the first conveying channel for transmitting plural paper sheets along the first conveying channel.

In an embodiment, the stapling device further includes at least one supporting structure. The at least one supporting structure is located near the first exit and located beside the first exit. After the plural paper sheets are departed from the channel base plate, the plural paper sheets are supported on the at least one supporting structure.

In an embodiment, when the movable contact plate is moved to a jam-releasing position near the first exit, the at least one supporting structure is located at a side of the movable contact plate.

In an embodiment, the stapling device further includes a connecting member. The connecting member is disposed on the stapling device casing and located near a printing device casing of the printing device to be connected with the printing device casing. The stapling device casing and the printing device casing of the printing device are combined together through the connecting member.

In an embodiment, the printing device casing includes at least one positioning hole and at least one fixing recess. The at least one positioning hole is exposed to a surface of the printing device casing. The at least one fixing recess is exposed to the surface of the printing device casing and located beside the at least one positioning hole. The connecting member includes at least one fixing hook and at least one positioning post. The at least one fixing hook is aligned with the at least one fixing recess, located at a side of the connecting member, swingable relative to the connecting member, inserted into the at least one fixing recess and engaged with the at least one fixing recess, so that the connecting member is fixed on the printing device casing, and the stapling device casing and the printing device casing are connected with each other through the connecting member. The at least one positioning post is aligned with the at least one positioning hole, located beside the at least one fixing hook, and inserted into the at least one positioning hole, so that the surface of the printing device casing is not in contact with the stapling device casing.

In an embodiment, the printing device further includes a connecting piece. The connecting piece is disposed on a surface of the printing device casing, and includes at least one positioning hole and at least one fixing recess. The at least one positioning hole is exposed to the surface of the printing device casing. The at least one fixing recess is located beside the at least one positioning hole. The connecting member includes at least one fixing hook and at least one positioning post. The at least one fixing hook is aligned with the at least one fixing recess, located at a side of the connecting member, swingable relative to the connecting member, inserted into the at least one fixing recess and engaged with the at least one fixing recess, so that the connecting member is fixed on the printing device casing. The stapling device casing and the printing device casing are connected with each other through the connecting member. The at least one positioning post is aligned with the at least one positioning hole, located beside the at least one fixing hook, and inserted into the at least one positioning hole, so that the surface of the printing device casing is not in contact with the stapling device casing.

In an embodiment, the printing device includes a printing device casing, a sheet input tray, a second exit, a second conveying channel, plural second conveying roller assemblies, and a printing module. The sheet input tray is located at a bottom of the printing device casing for placing the plural paper sheets thereon. The second exit is formed in the printing device casing, wherein the plural paper sheets are exited out of the printing device casing through the second exit. The second conveying channel is arranged between the sheet input tray and second first exit for allowing the plural paper sheets to go through. The plural second conveying roller assemblies are disposed in the second conveying channel for moving the plural paper sheets along the second conveying channel. The printing module is disposed in the second conveying channel for printing the plural paper sheets.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side view illustrating a conventional stapling device for use with a printing device;

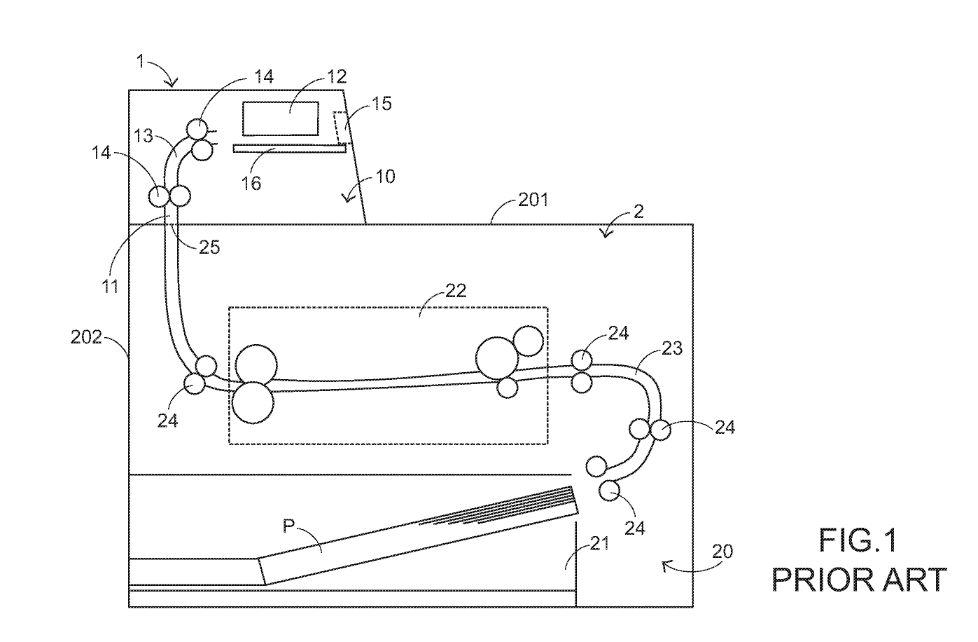

FIG. 2 is a schematic side view illustrating the conventional stapling device of FIG. 1, in which a paper jam event occurs within the stapling device;

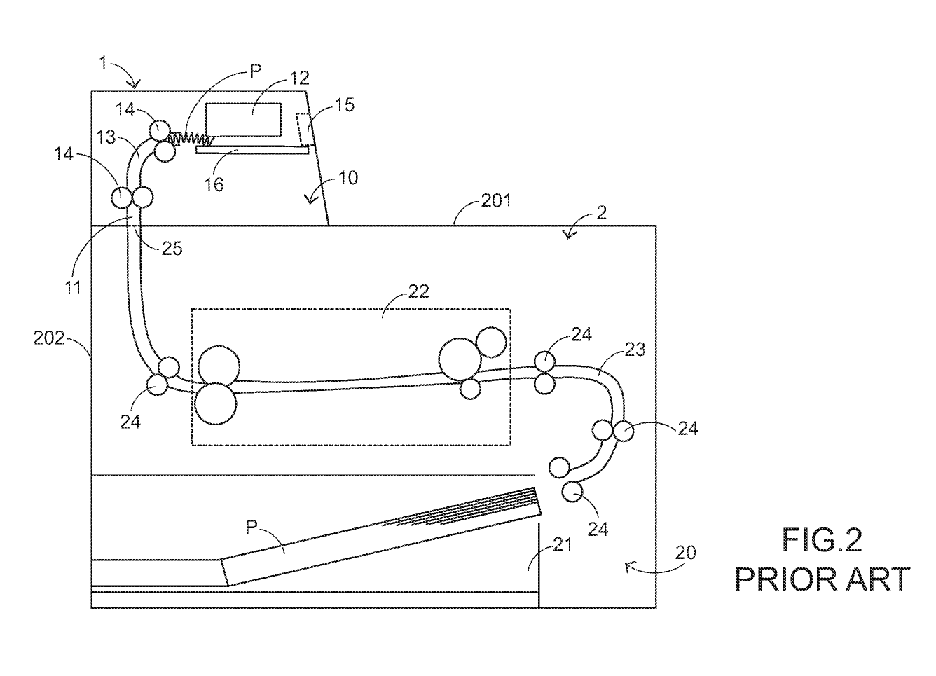

FIG. 3 is a schematic exploded view illustrating a stapling device for use with a printing device according to an embodiment of the present invention;

FIG. 4 is schematic exploded view illustrating a connecting member of the stapling device and a printing device casing of the printing device according to an embodiment of the present invention, and taken along another viewpoint;

FIG. 5 is a schematic side view illustrating the stapling device and the printing device according to an embodiment of the present invention;

FIG. 6 is a schematic perspective view illustrating a channel base plate of the stapling device according to an embodiment of the present invention, in which the channel base plate is in a sheet-feeding position;

FIG. 7 is a schematic side view illustrating the stapling device and the printing device according to an embodiment of the present invention, in which a paper jam event occurs within the stapling device;

FIG. 8 is a schematic perspective view illustrating the channel base plate of the stapling device according to an embodiment of the present invention, in which the channel base plate of is moved to a jam-releasing position;

FIG. 9 is a schematic side view illustrating the stapling device according to an embodiment of the present invention, in which the channel base plate of is in the jam-releasing position; and

FIG. 10 is a schematic perspective view illustrating a connecting mechanism between the stapling device and the printing device according to another embodiment of the present invention, and taken along another viewpoint.

### DETAILED DESCRIPTION OF THE PREFERRED EMBODIMENT

For eliminating the drawbacks encountered from the prior art, the present invention provides a stapling device for use with a printing device. The stapling device has a stapling device casing. The stapling device casing can be easily detached without the need of using an additional tool.

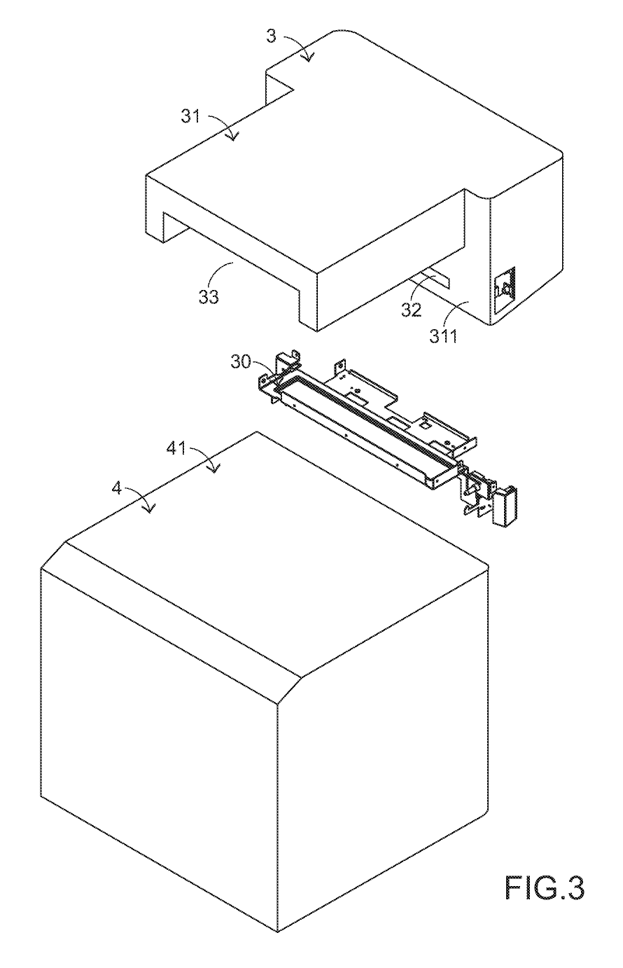

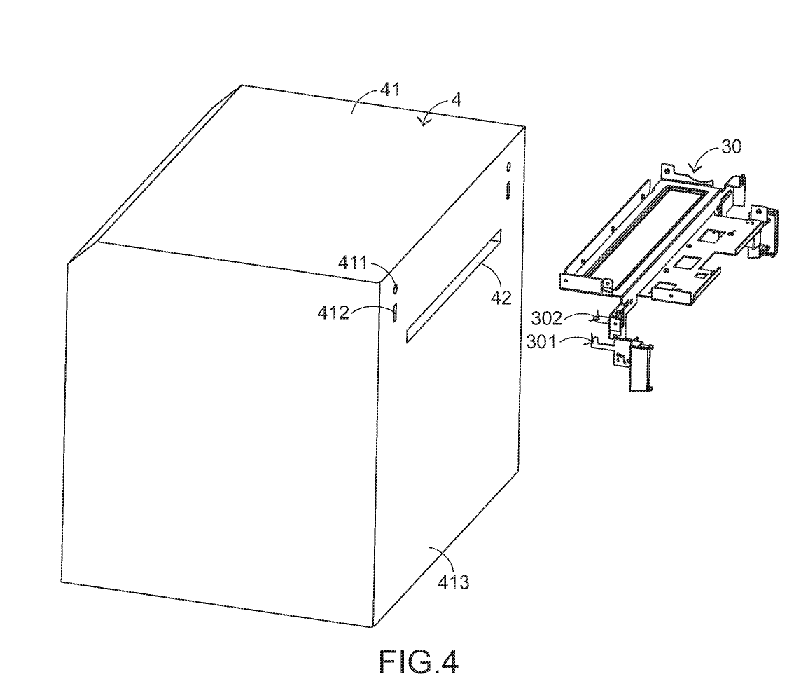

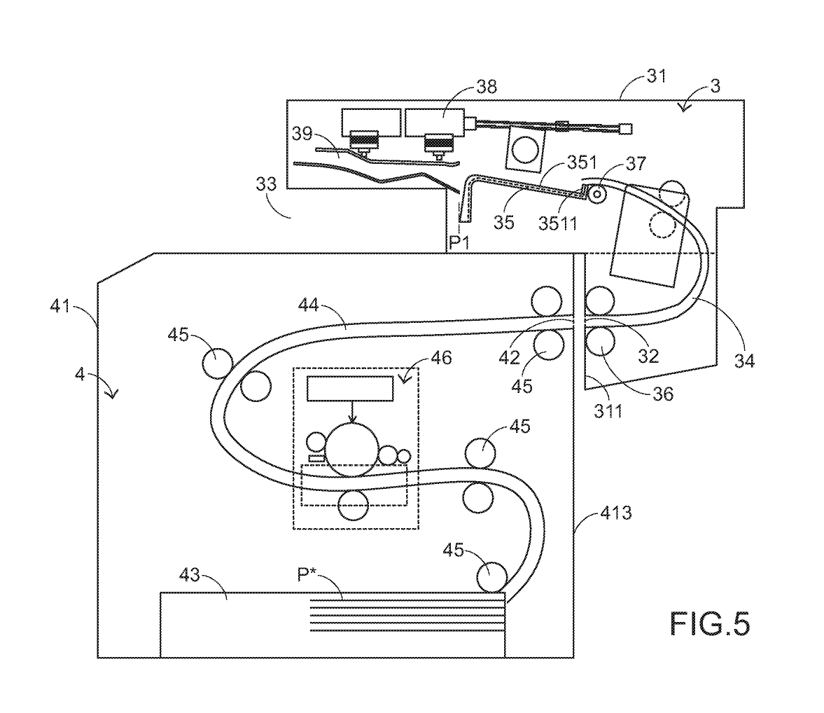

Please refer to FIGS. 3 and 4. FIG. 3 is a schematic exploded view illustrating a stapling device for use with a printing device according to an embodiment of the present invention. FIG. 4 is schematic exploded view illustrating a connecting member of the stapling device and a printing device casing of the printing device according to an embodiment of the present invention, and taken along another viewpoint. In FIG. 3, a stapling device casing 31 of a stapling device 3, a connecting member 30 of the stapling device 3 and a printing device 4 are shown. The printing device 4 is used for printing images on plural paper sheets P* (see FIG. 5). The stapling device 3 is used for stapling the plural paper sheets P* from the printing device 4. The connecting member 30 is disposed on the stapling device casing 31 of the stapling device 3. Through the connecting member 30, the stapling device casing 31 and the printing device casing 41 of the printing device 4 are combined together.

In addition to the stapling device casing 31 and the connecting member 30, the stapling device 3 further comprises an entrance 32 and a first exit 33 (see FIG. 3). The entrance 32 is formed in the stapling device casing 31, and located near the printing device 4. The plural paper sheets P* outputted from the printing device 4 may be introduced into the stapling device casing 31 through the entrance 32. The first exit 33 is formed in the stapling device casing 31 for allowing the plural paper sheets P* to go through, so that the plural paper sheets P* are exited out of the stapling device 3 through the first exit 33. In addition, the dimension of the first exit 33 is designed to allow a user's finger to be inserted thereto (see FIG. 3).

Please refer to FIGS. 3 and 4. The printing device 4 comprises a second exit 42. The second exit 42 is formed in a surface 413 of the printing device casing 41 for allowing the plural paper sheets P* to go through, so that the plural paper sheets P* are exited out of the printing device casing 41 through the second exit 42. Moreover, the printing device casing 41 comprises at least one positioning hole 411 and at least one fixing recess 412 corresponding to the at least one positioning hole 411. The at least one positioning hole 411 is exposed to the surface 413 of the printing device casing 41. The at least one fixing recess 412 is exposed to the surface 413 of the printing device casing 41, and located beside the corresponding positioning hole 411. The connecting member 30 comprises at least one fixing hook 301 and at least one positioning post 302. The at least one fixing hook 301 is aligned with the at least one fixing recess 412. In addition, the at least one fixing hook 301 is located at a side of the connecting member 30, and may be swung relative to the connecting member 30. The at least one fixing hook 301 is inserted into the corresponding fixing recess 412, and engaged with the fixing recess 412. Consequently, the connecting member 30 is fixed on the printing device casing 41, and the stapling device casing 31 and the printing device casing 41 are connected with each other through the connecting member 30. The at least one positioning post 302 is aligned with the at least one positioning hole 411, and located beside the at least one fixing hook 301. Moreover, the at least one positioning post 302 is inserted into the at least one positioning hole 411, so that the surface 413 of the printing device casing 41 is not in contact with the stapling device casing 31. In this embodiment, the connecting member 30 is a frame structure.

FIG. 5 is a schematic side view illustrating the stapling device and the printing device according to an embodiment of the present invention. The connection between the stapling device casing 31 and the printing device casing 41 will be illustrated with reference to FIG. 5. Moreover, as shown in FIG. 5, the surface 413 of the printing device casing 41 is separated from a surface 311 of the stapling device casing 31 by a gap. Due to the gap between the printing device casing 41 and the stapling device casing 31, the plural paper sheets P* can be smoothly transmitted from the second exit 42 of the printing device casing 41 to the entrance 32 of the stapling device casing 31. It is noted that the distance between the printing device casing 41 and the stapling device casing 31 should be elaborately controlled. If the distance between the printing device casing 41 and the stapling device casing 31 is too small or too large, the plural paper sheets P* fail to be smoothly transmitted to the entrance 32 of the stapling device casing 31 or the plural paper sheets P* fail to be introduced into the entrance 32. In an embodiment, the distance between the printing device casing 41 and the stapling device casing 31 is obtained by undue experiments.

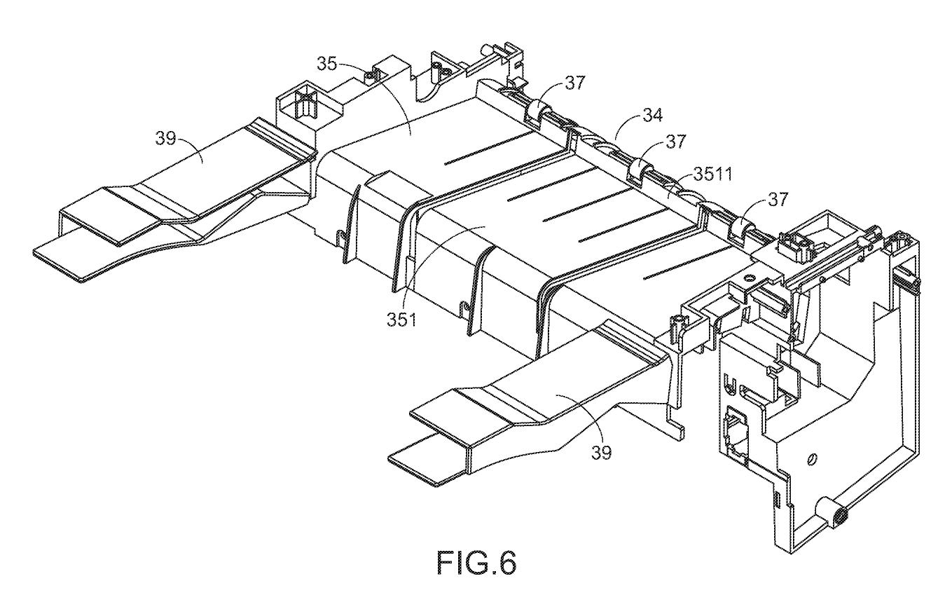

FIG. 6 is a schematic perspective view illustrating a channel base plate of the stapling device according to an embodiment of the present invention, in which the channel base plate is in a sheet-feeding position. Please refer to FIGS. 5 and 6. In addition to the above components, the stapling device 3 further comprises a first conveying channel 34, a channel base plate 35, a feed roller assembly 36, a first conveying roller assembly 37, a stapling module 38, and at least one supporting structure 39. The first conveying channel 34 is arranged between the entrance 32 and the first exit 33 for allowing the plural paper sheets P* to go through. The channel base plate 35 is located at a bottom side of the first conveying channel 34. Moreover, the channel base plate 35 has a movable contact plate 351. The movable contact plate 351 is used for contacting the plural paper sheets P* within the first conveying channel 34. By poking the movable contact plate 351, the movable contact plate 351 is movable relative to the channel base plate 35. Moreover, the movable contact plate 351 has a pushing slice 3511. The pushing slice 3511 is used for contacting the plural paper sheets P* within the first conveying channel 34. In this embodiment, the pushing slice 3511 is integrally formed with the movable contact plate 351.

The feed roller assembly 36 is disposed in the first conveying channel 34 and located near the entrance 32 for transporting the plural paper sheets P* into the first conveying channel 34. The first conveying roller assembly 37 is disposed on the channel base plate 35 and located near the first conveying channel 34. By the first conveying roller assembly 37, the plural paper sheets P* are moved along the first conveying channel 34. The stapling module 38 is disposed within the stapling device casing 31 and located over the first exit 33 for stapling the plural paper sheets P*. The at least one supporting structure 39 is located near the first exit 33, and located beside the first exit 33. After the plural paper sheets P* are departed from the channel base plate 35, the plural paper sheets P* are supported on the at least one supporting structure 39. Next, the plural paper sheets P* may be stapled by the stapling module 38.

Please refer to FIG. 5 again. In addition to above components, the printing device 4 further comprises a sheet input tray 43, a second conveying channel 44, plural second conveying roller assemblies 45, and a printing module 46. The sheet input tray 43 is located at a bottom of the printing device casing 41 for placing the plural paper sheets P* thereon. The second conveying channel 44 is arranged between the sheet input tray 43 and the second exit 42 for allowing the plural paper sheets P* to go through. The plural second conveying roller assemblies 45 are disposed in the second conveying channel 44 for moving the plural paper sheets P* along the second conveying channel 44. The printing module 46 is disposed in the second conveying channel 44 for printing images on the plural paper sheets P*.

Please refer to FIG. 5 again. A process of using the printing device 4 to print images on the plural paper sheets P* and using the stapling device 3 to staple the plural paper sheets P* will be illustrated in more details as follows. Firstly, the plural paper sheets P* are placed on the sheet input tray 43. Then, the plural paper sheets P* are successively transported into the second conveying channel 44 by the plural second conveying roller assemblies 45. When the plural paper sheets P* are moved along the second conveying channel 44 and transported across the printing module, the images are printed on the plural paper sheets P*. After the plural paper sheets P* are printed, the printed paper sheets P* are continuously transported by the plural second conveying roller assemblies 45 and moved along the second conveying channel 44. Then, the plural paper sheets P* are exited out of the printing device casing 41 through the second exit 42.

After the plural paper sheets P* are exited out of the printing device casing 41, plural paper sheets P* are introduced into the stapling device 3 through the entrance 32, which is formed in the stapling device casing 31. Then, the plural paper sheets P* are transported by the feed roller assembly 36 to be fed into the first conveying channel 34, and the plural paper sheets P* are moved along the first conveying channel 34. Next, the plural paper sheets P* are contacted with the first conveying roller assembly 37 and the movable contact plate 351, which are disposed on the channel base plate 35. Consequently, the plural paper sheets P* are transported toward the first exit 33 by the first conveying roller assembly 37. Moreover, after the plural paper sheets P* are departed from the channel base plate 35, the plural paper sheets P* are contacted with and supported on the at least one supporting structure 39, which is located beside the first exit 33. Next, the plural paper sheets P* on the supporting structure 39 are stapled by the stapling module 38. After the plural paper sheets P* are stapled, the user's finger may be inserted into the first exit 33 to remove the plural paper sheets P* from the supporting structure 39. The process of smoothly transmitting the plural paper sheets P* through the printing device 4 and the stapling device 3 has been described as above.

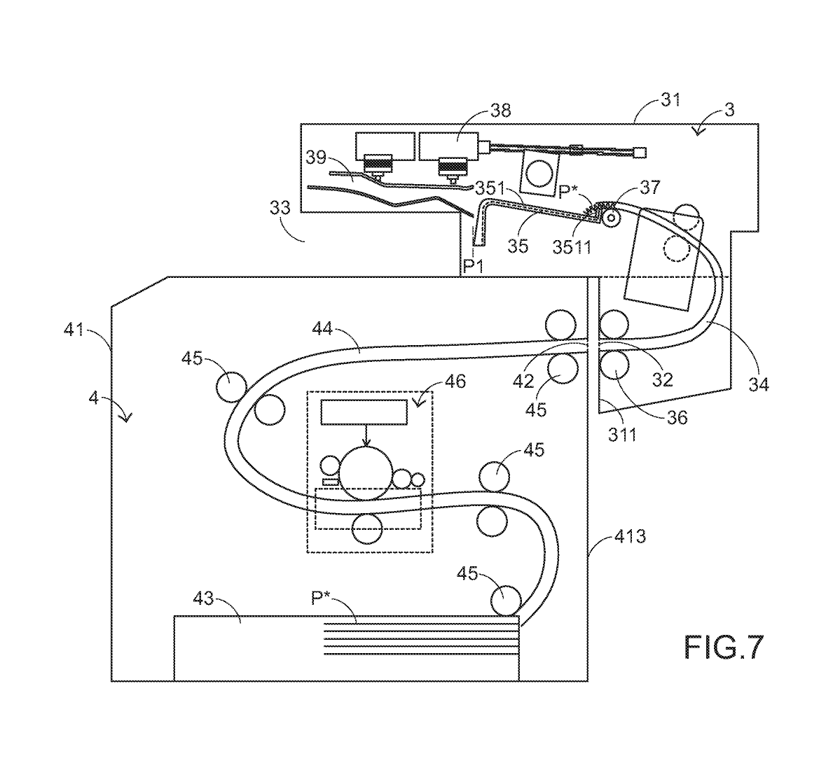

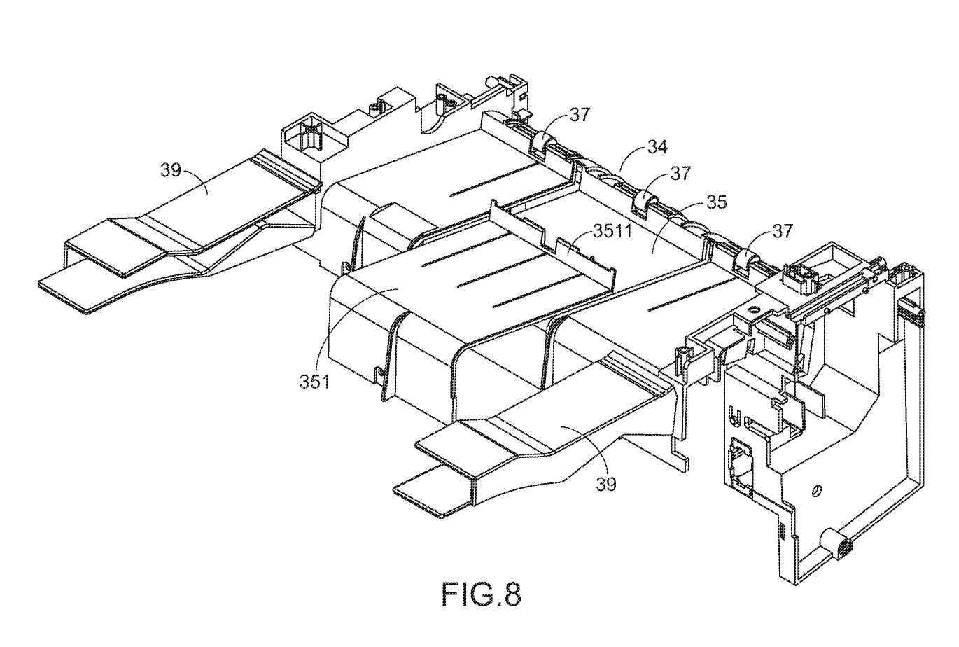

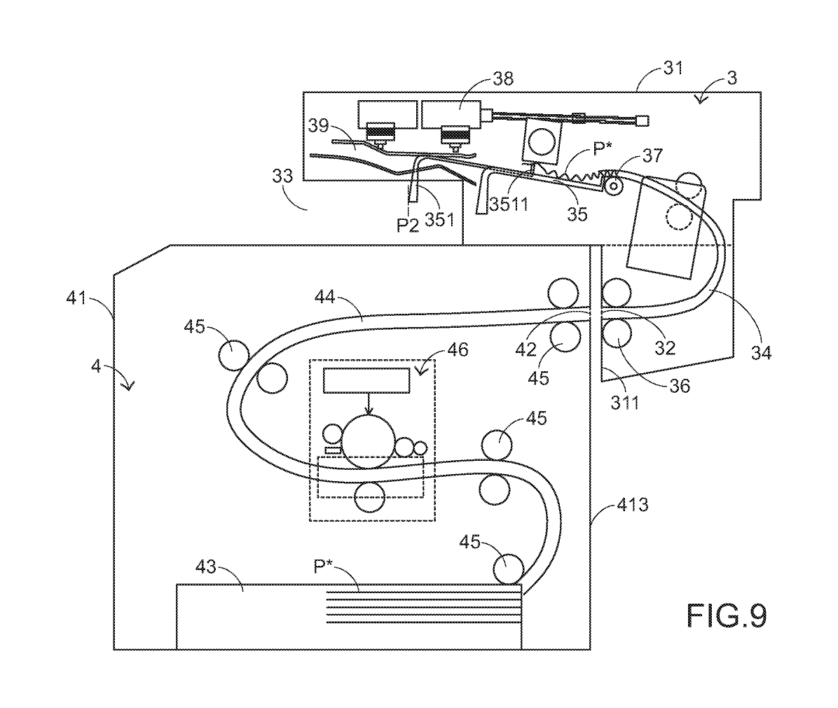

Hereinafter, a way of eliminating the paper jam event of the plural paper sheets P* will be illustrated with reference to FIGS. 7, 8 and 9. FIG. 7 is a schematic side view illustrating the stapling device and the printing device according to an embodiment of the present invention, in which a paper jam event occurs within the stapling device. After one of the plural paper sheets P* is printed by the printing device 4 and transmitted to the stapling device 3, the paper sheet P* is possibly jammed between the first conveying roller assembly 37 and the movable contact plate 351. For removing the jammed paper sheet P*, the user's finger may be inserted into the first exit 33 to poke the movable contact plate 351 of the channel base plate 35, so that the movable contact plate 351 is moved from a sheet-feeding position P1 (see FIG. 5) to a jam-releasing position P2 (see FIGS. 8 and 9). The jam-releasing position P2 is located near the first exit 33. Moreover, during the movable contact plate 351 is poked and moved relative to the channel base plate 35, the jammed paper sheet P* is pushed by the pushing slice 3511 of the movable contact plate 351 to the position near the first exit 33. Meanwhile, the user's finger may be inserted into the first exit 33 to be contacted with the jammed paper sheet P*. After the jammed paper sheet P* is removed, the paper jam event is eliminated. Moreover, as shown in FIG. 8, when the movable contact plate 351 is moved to the jam-releasing position P2, the at least one supporting structure 39 is located at a side of the movable contact plate 351.

After paper jam event is eliminated, the user may push the movable contact plate 351 to have the movable contact plate 351 move relative to the channel base plate 35. When the movable contact plate 351 is moved from the jam-releasing position P2 to the sheet-feeding position P1, the paper sheets P* can be smoothly transmitted along the first conveying channel 34 (see FIG. 5).

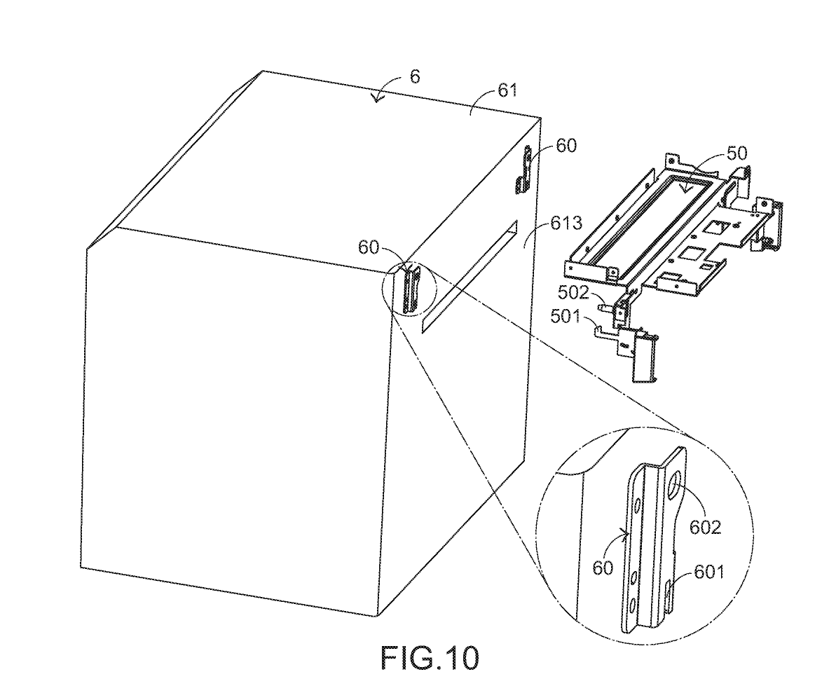

However, those skilled in the art will readily observe that numerous modifications and alterations may be made while retaining the teachings of the invention. For example, the connecting mechanism between the stapling device and the printing device may be altered according to the practical requirements. FIG. 10 is a schematic perspective view illustrating a connecting mechanism between the stapling device and the printing device according to another embodiment of the present invention, and taken along another viewpoint. In FIG. 10, a connecting member 50 and a printing device 6 are shown. The configurations of the stapling device are identical to those of the above embodiment, and are not redundantly described herein and not shown in FIG. 10. Moreover, the printing device 6 comprises at least one connecting piece 60 and a printing device casing 61. The at least one connecting piece 60 is disposed on a surface 613 of the printing device casing 61 to be connected with a connecting member 50 of the stapling device. Moreover, the connecting piece 60 comprises a positioning hole 601 and a fixing recess 602. The positioning hole 601 is exposed to the surface 613 of the printing device casing 61. The fixing recess 602 is exposed to the surface 613 of the printing device casing 61, and located beside the positioning hole 601. The connecting member 50 comprises at least one fixing hook 501 and at least one positioning post 502. The fixing hook 501 is aligned with the fixing recess 612. In addition, the fixing hook 501 is located at a side of the connecting member 50, and may be swung relative to the connecting member 50. The fixing hook 501 is inserted into the corresponding fixing recess 601, and engaged with the fixing recess 601. Consequently, the connecting member 50 is fixed on the printing device casing 61, and the stapling device and the printing device casing 61 are connected with each other through the connecting member 50. The positioning post 502 is aligned with the positioning hole 601, and located beside the fixing hook 501. Moreover, the positioning post 502 is inserted into the positioning hole 601, so that the surface 613 of the printing device casing 61 is not in contact with the stapling device. The configurations of other components of the printing device 6 are similar to those of the above embodiment, and are not redundantly described herein.

In this embodiment, the printing device 6 further comprises the connecting piece 60, and the connecting piece 60 comprises the positioning hole 601 and the fixing recess 602. That is, the printing device casing has no positioning hole and no fixing recess to be connected with the connecting member. By attaching the connecting piece 60 on the surface 613 of the printing device casing 61, the user may easily combine the connecting member 50 with the printing device 6 without the need of punching holes in the printing device casing 61. Moreover, in some other embodiments, the connecting member is not necessarily a frame structure. For example, the connecting member may be a screwing means, and the printing device casing and the stapling device casing may be combined together by the screwing means.

From the above description, the present invention provides a stapling device for use with a printing device. A channel base plate is located at a bottom side of the conveying channel of the stapling device. The channel base plate has a movable contact plate. By poking the movable contact plate, the movable contact plate may be moved relative to the channel base plate. Even if a paper jam event occurs within the stapling device, the movable contact plate may be moved to a jam-releasing position which is touchable by the user's finger. Consequently, the user can easily remove the jammed paper sheet the without the need of using an additional tool. Moreover, since the stapling device casing is an L-shaped casing, only a part of the rear surface and a part of the top surface of the printing device casing are the overlapping region between the stapling device casing and the printing device casing. That is, since the stapling device casing is not just disposed over the printing device casing, the overall height of the stapling device and the printing device can be reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A stapling device for use with a printing device, said stapling device being disposed on said printing device for stapling plural paper sheets from said printing device, said stapling device comprising:
a stapling device casing;
an entrance formed in said stapling device casing and located near said printing device, wherein said plural paper sheets outputted from said printing device are introduced into said stapling device through said entrance;
a first exit formed in said stapling device casing, wherein said plural paper sheets are exited out of said stapling device through said first exit;
a first conveying channel arranged between said entrance and said first exit for allowing said plural paper sheets to go through; and
a channel base plate located at a bottom side of the first conveying channel, wherein said channel base plate has a movable contact plate to be contacted with said plural paper sheets within said first conveying channel, wherein by poking said movable contact plate, said movable contact plate is moved relative to said channel base plate, so that said plural paper sheets are correspondingly moved to a position near said first exit to be removed from said first exit.

2. The stapling device according to claim 1, wherein when said movable contact plate is moved from a sheet-feeding position to a jam-releasing position near said first exit, said plural paper sheets are removable from said movable contact plate through said first exit, wherein when said movable contact plate is pushed to be moved from said jam-releasing position to said sheet-feeding position, said paper sheets are permitted to be transmitted along said first conveying channel.

3. The stapling device according to claim 1, wherein said movable contact plate has a pushing slice for contacting said plural paper sheets within said first conveying channel, wherein when said movable contact plate is poked and moved relative to said movable contact plate, said plural paper sheets are pushed by said pushing slice to said position near the first exit, so that said plural paper sheets are removable through said first exit.

4. The stapling device according to claim 1, further comprising:
a stapling module disposed within said stapling device casing and located over said first exit for stapling said plural paper sheets;
a feed roller assembly disposed in said first conveying channel and located near said entrance for transporting said plural paper sheets into said first conveying channel; and
a first conveying roller assembly disposed on said channel base plate and located near said first conveying channel for transmitting plural paper sheets along said first conveying channel.

5. The stapling device according to claim 1, further comprising at least one supporting structure, which is located near said first exit and located beside said first exit, wherein after said plural paper sheets are departed from said channel base plate, said plural paper sheets are supported on said at least one supporting structure.

6. The stapling device according to claim 5, wherein when said movable contact plate is moved to a jam-releasing position near said first exit, said at least one supporting structure is located at a side of said movable contact plate.

7. The stapling device according to claim 1, further comprising a connecting member, which is disposed on said stapling device casing and located near a printing device casing of said printing device to be connected with said printing device casing, wherein said stapling device casing and the printing device casing of said printing device are combined together through said connecting member.

8. The stapling device according to claim 7, wherein said printing device casing comprises at least one positioning hole and at least one fixing recess, wherein said at least one positioning hole is exposed to a surface of said printing device casing, and said at least one fixing recess is exposed to said surface of said printing device casing and located beside said at least one positioning hole, wherein said connecting member comprises at least one fixing hook and at least one positioning post, wherein said at least one fixing hook is aligned with said at least one fixing recess, located at a side of said connecting member, swingable relative to said connecting member, inserted into said at least one fixing recess and engaged with said at least one fixing recess, so that said connecting member is fixed on said printing device casing, and said stapling device casing and said printing device casing are connected with each other through said connecting member, wherein said at least one positioning post is aligned with said at least one positioning hole, located beside said at least one fixing hook, and inserted into said at least one positioning hole, so that said surface of said printing device casing is not in contact with said stapling device casing.

9. The stapling device according to claim 7, wherein said printing device further comprises a connecting piece, wherein said connecting piece is disposed on a surface of said printing device casing, and comprises at least one positioning hole and at least one fixing recess, wherein said at least one positioning hole is exposed to said surface of said printing device casing, and said at least one fixing recess is located beside said at least one positioning hole, wherein said connecting member comprises at least one fixing hook and at least one positioning post, wherein said at least one fixing hook is aligned with said at least one fixing recess, located at a side of said connecting member, swingable relative to said connecting member, inserted into said at least one fixing recess and engaged with said at least one fixing recess, so that said connecting member is fixed on said printing device casing, and said stapling device casing and said printing device casing are connected with each other through said connecting member, wherein said at least one positioning post is aligned with said at least one positioning hole, located beside said at least one fixing hook, and inserted into said at least one positioning hole, so that said surface of said printing device casing is not in contact with said stapling device casing.

10. The stapling device according to claim 1, wherein said printing device comprises:
a printing device casing;
a sheet input tray located at a bottom of said printing device casing for placing said plural paper sheets thereon;
a second exit formed in said printing device casing, wherein said plural paper sheets are exited out of said printing device casing through said second exit;
a second conveying channel arranged between said sheet input tray and second first exit for allowing said plural paper sheets to go through;
plural second conveying roller assemblies disposed in said second conveying channel for moving said plural paper sheets along said second conveying channel; and
a printing module disposed in said second conveying channel for printing said plural paper sheets.
